(19) United States
(12) Patent Application Publication
(10) Pub. No.: US 2015/0168164 A1
(43) Pub. Date: Jun. 18, 2015

(54) METHOD AND DEVICE FOR GENERATING SMART MAP ROUTE NAVIGATION

(71) Applicant: Google Technology Holdings LLC, Mountain View, CA (US)

(72) Inventors: Vishal Shashikant Patil, Bangalore (IN); Sindhu Chamathakundil, Bangalore (IN); Jeevitha Jayanth, Bangalore (IN)

(21) Appl. No.: 14/227,389

(22) Filed: Mar. 27, 2014

Related U.S. Application Data
(60) Provisional application No. 61/915,191, filed on Dec. 12, 2013.

(51) Int. Cl. G01C 21/34; H04W 4/02

(52) U.S. Cl. CPC G01C 21/34; H04W 4/028; H04W 88/02

(57) ABSTRACT

Devices and methods for determining an optimal travel route from an origin to a destination for a first device are disclosed. In some embodiments, the method includes: determining an origin and destination for a travel objective and determining whether a user is on a phone call or predicted to be on a phone call during the travel objective using context information associated with the first device. When the user is on a phone call, the method determines a phone call duration using the context information associated with the first device and uses the phone call duration to determine an optimal travel route. When the user is predicted to be on a phone call and the phone call is predicted to be ongoing when a call drop point is encountered, the method determines a phone call duration using the context information associated with the first device, and uses the phone call duration to determine an optimal travel route.

### TECHNICAL FIELD

The present disclosure is related generally to a communication device and, more particularly, to a method and communication device for generating a map route navigation using call prediction, call duration, and/or call drop prediction.

### BACKGROUND

Today, mobile communications devices, such as mobile telephones, are commonplace. Yet despite their near-ubiquity, there are still many areas where mobile communications devices lack coverage or certain wireless services are unavailable. The user of a device usually finds out about a lack of coverage when he or she moves out of the coverage area and drops a call or loses service when traveling. By the time the call or service is dropped, it is too late for the user to take steps to remain in the coverage area or take other actions in preparation for the termination of the ongoing communication.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an overview of a representative environment in which the present techniques may be practiced;

FIG. 2 is a generalized schematic of a mobile device shown in FIG. 1;

FIG. 3 is an example mobile device displaying route information according to present techniques;

FIG. 4 is a flowchart of a representative method for determining a travel route according to present techniques;

FIG. 5 is a generalized schematic of an example notification provided to a user of an impending call drop;

FIG. 6 is a flowchart of a representative method for determining a travel route according to present techniques; and

FIG. 7 is a flowchart of a representative method for determining a travel route according to present techniques.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

Many people spend a considerable amount of time traveling or commuting between their home and place of employment. During this commute time, people often make business or personal calls. With the popularity of GPS and maps-based navigation applications such as Google Maps, people depend heavily on maps for route navigation, as they provide live feeds on traffic status, best route, shortest path, etc. based on a few conventional algorithms. However, these algorithms generally do not monitor for call drop points on a selected route, leading to disruption in ongoing calls.

Provided herein are devices and methods that take into account call prediction (i.e., likelihood that a call will take place), call duration prediction, and/or call drop information to provide enhanced routing navigation for users engaged on a phone call during travel. Such devices and methods allow the user to have a better navigation experience by minimizing and/or avoiding dropped calls.

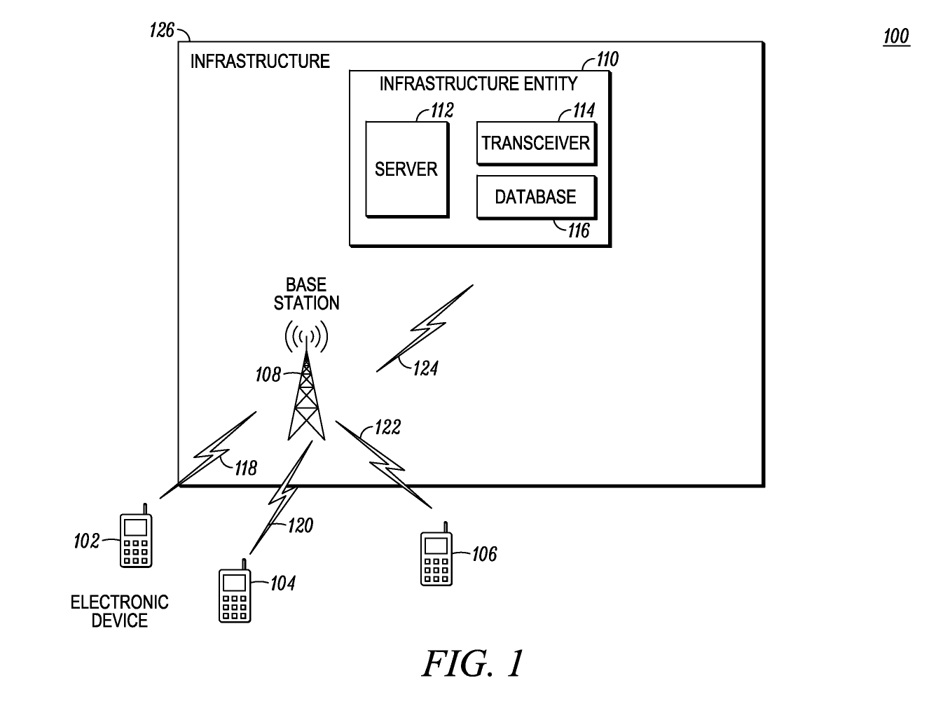

FIG. 1 illustrates a schematic of a wireless communication system 100 in accordance with some embodiments. The wireless communication system 100 includes one or more electronic devices 102, 104, 106 communicating with infrastructure 126. The infrastructure 126 may include one or more base stations 108 and an infrastructure entity 110 communicating with the base station 108 via wireless or wired link 124 (for example, landline connections such as fiber optic or copper wiring connections, microwave communications, radio channel communications, and/or wireless path communications).

In some embodiments, the base station 108 in the wireless communication system 100 is configured to operate according to any of a number of different communication technologies including, but not limited to, 2G, 3G and 4G wireless communication technologies. These include Global System for Mobile Communication (GSM), Code Division for Multiple Access (CDMA), Universal Mobile Telecommunication System (UMTS), Wideband Code Division for Multiple Access (W-CDMA), Orthogonal Frequency Division Multiplexing (OFDM), Worldwide Interoperability for Microwave Access (WiMax), Long-Term Evolution (LTE) and other communication technologies. The base station 108 communicates with the electronic devices 102-106 via the wireless or wired links 118, 120, 122.

Electronic devices 102-106 are representative of any of a variety of electronic communication devices operated by persons (or users) or possibly by other entities (e.g., other computers) desiring or requiring communication capabilities. In some embodiments, for example, electronic devices 102-106 can be any of a personal digital assistant (PDA), a smart phone, another handheld or portable electronic device, an MP3 player, a laptop or notebook computer, a PMP (personal media player), a gaming device, a tablet device, a navigation device with a video capable screen, or a general purpose computer.

The infrastructure entity 110 is a network element that is connected to the various other elements in the wireless communication system 100. For example, the infrastructure entity 110 is connected to the electronic devices 102-106 through the base station 108 serving the electronic devices 102-106. The infrastructure entity 110 routes the communications to electronic devices 102-106 via base station 108 or via a PSTN/Internet/other network elements. The infrastructure entity 110 includes the server 112, the transceiver 114, and the database 116. The server 112 is a network element that communicates either directly or via other network elements to the base station 108. The server may include a transceiver component and/or a database component, or the server may communicate with a transceiver 114 and/or database 116 of the infrastructure entity 110. The server 112 is also representative of any computerized device or terminal (or several of these) with which the electronic devices 102-106 and the base station 108 are capable of communicating, for the purpose of receiving or transmitting information.

The transceiver unit 114 can be implemented as a transmitting and receiving component of the infrastructure entity 110. In some embodiments, the transceiver 114 enables the infrastructure entity 110 to transmit and receive the RF signals through an antenna (not shown). As mentioned before, the transceiver 114 may be a part of the server 112 and not necessarily a separate element in the infrastructure entity 110. The database 116 stores the information and data related to the electronic devices 102-106 connected to the infrastructure entity 110 and various other data required by the server 112. Also, the database 116 may be a part of server 112 and not necessarily a separate element in the infrastructure entity 110. In some embodiments, server 112 is a cloud server configured to gather information that may aid in deriving navigation details, such as drop data/map details.

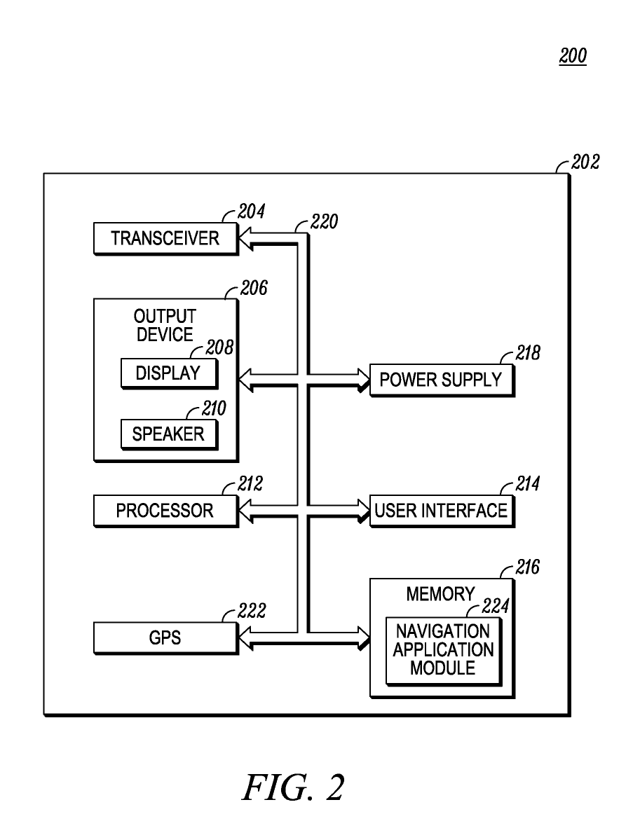

FIG. 2 illustrates a schematic 200 of the internal hardware components of a mobile device of FIG. 1. For the purposes of the explanation below, the schematic 200 will be referred to as describing internal hardware components of a communication device 202. Herein, the communication device 202 may refer to electronic device 102-106 and/or the server 112.

The schematic 200 of the communication device 202 includes various components. The exemplary components include a transceiver 204, an output device 206 including a display 208 and a speaker 210, a processor 212, a user interface 214, a memory 216, power supply 218, and global positioning system (GPS) 222, each capable of communicating with one or more components of the communication device 202. For example, as shown in FIG. 2, all components are coupled to a bidirectional system bus 220.

In some embodiments, the transceiver unit 204 can be implemented as a transmitting and receiving component of the communication device 201. The transceiver 204 enables the communication device 202 to transmit and receive the RE signals through an antenna (not shown). In some embodiments, the transceiver 204 converts the RE signals received from the antenna to digital data for use by the processor 212.

The output device 206 may generate visual indications of data generated during operation of the processor 212. The visual indications may include prompts for human operator input, calculated values, detected data, etc. Additionally, the output device 206 may include a video output component such as a display device 208 which includes cathode ray tube (CRT), liquid crystal display (LCD), plasma display, incandescent light, fluorescent light, front or rear projection display, or light emitting diode (LED) indicator. Other examples of output components 206 include an audio output component such as a speaker 210, alarm and/or buzzer, and/or a mechanical output component such as vibrating or motion-based.

In some embodiments, the user interface 214 may be connected to the processor 212 for entering data and commands in the form of text, touch input, gestures, etc. The user interface 214 is, in some embodiments, a touch screen device but may alternatively be an infrared proximity detector or any input/output device combination capable of sensing gestures and/or touch including a touch-sensitive surface. In addition, the user interface 214 may include one or more additional components, such as a video input component such as an optical sensor (for example, a camera), an audio input component such as a microphone, and a mechanical input component such as button or key selection sensors, touch pad sensor, another touch-sensitive sensor, capacitive sensor, motion sensor, and may include a pointing device such as a joystick and buttons used on laptop or notebook computers, a track ball, a touch pad, a rocker switch, a touch screen, etc. The user interface 214 enables a user of the communication device 202 to provide an input for the communication device 202.

Memory 216 may be used to store data and instructions for the operation of the processor 212. In the various embodiments, the memory 216 may be one or more separate components and/or may be partitioned in various ways for various purposes such as but not limited to, optimizing memory allocations, etc. As shown, memory 216 may include one or more modules for achieving various tasks. For example, memory 216 may include navigation application module 224, which provides determinations on routing information for a user seeking directions. In some embodiments, navigation application module 224 uses various inputs such as context information and selects an algorithm based on the context information to provide routing information to a user. In some embodiments, the navigation application module 224 may communicate with a cloud server (e.g., server 112) to retrieve various other inputs such as cellular signal statistics (e.g., call drop) and map information. This information may be stored in the cloud server or locally in memory 216, for example.

Power supply 218, such as a battery, may be include in the internal components of the communication device 202 for providing power to the other internal components while enabling the communication device 202 to be portable.

GPS system 222 may be included in the internal components of the communication device 202, enabling communication device 202 to communicate with GPS satellites and determine its own location, speed, direction, and current time. In some embodiments, GPS system 222 is in communication with memory 216 and navigation application module 224 to determine routing information.

Processor 212 operates in conjunction with the data and instructions stored in the memory 216 to control the operation of the communication device 202. The processor 212 may be implemented as a microcontroller, a digital signal processor, hard-wired logic and analog circuitry, or any suitable combination of these.

As provided above, the present disclosure is related to improving existing map routing technologies. In some embodiments, the present routing methods include the consideration of call drop points and call start time/call duration prediction while navigating. For example, present methods may include: (1) predicting whether and/or when a call may occur during the travel time based on context information; (2) predicting the call duration based on context information; and (3) selecting the best/optimal route using call drop information. Based on the information from items (1), (2), and (3), the present methods may select the best/optimal route to prevent call drops or inform the user of possible call drops if the selected route has an unavoidable call drop point. Optimal route as used herein refers to the best or most efficient route in terms of time and/or distance while avoiding or minimizing dropped calls.

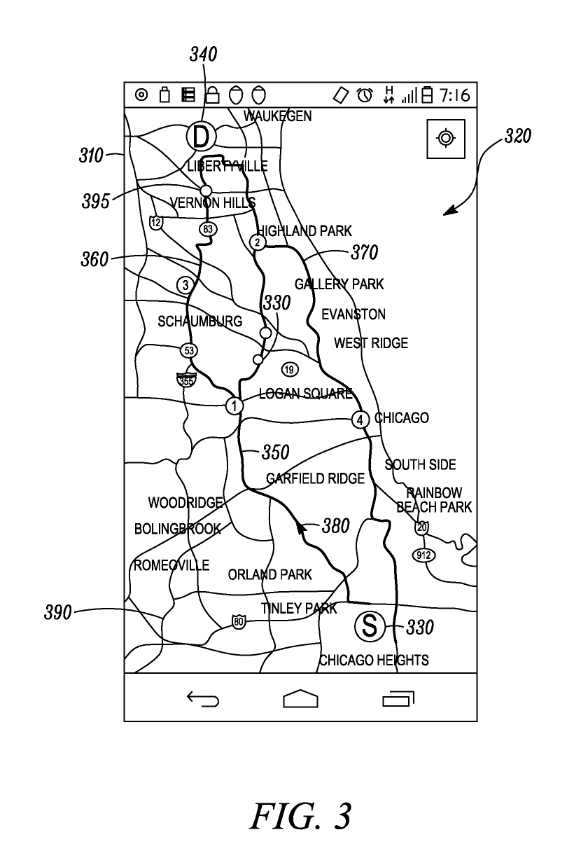

FIG. 3 depicts an example mobile device 310 displaying suggested route information according to embodiments of the present disclosure. Mobile device 310 includes an interface 320 that depicts map information. Several routes are shown for traveling between an origin 330 and a destination 340. In particular routes A (350), B (360) and C (370) are shown. In addition, the interface 320 includes a location indicator 380 that indicates the current location of the mobile device 310 along the travel route 350.

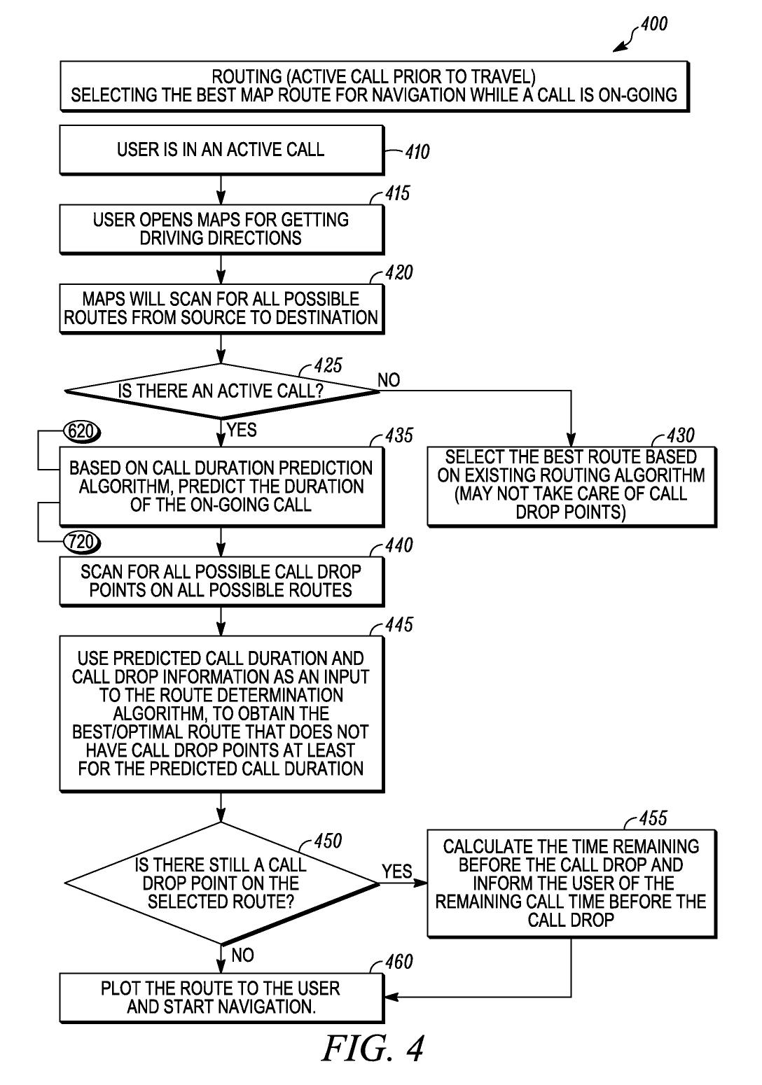

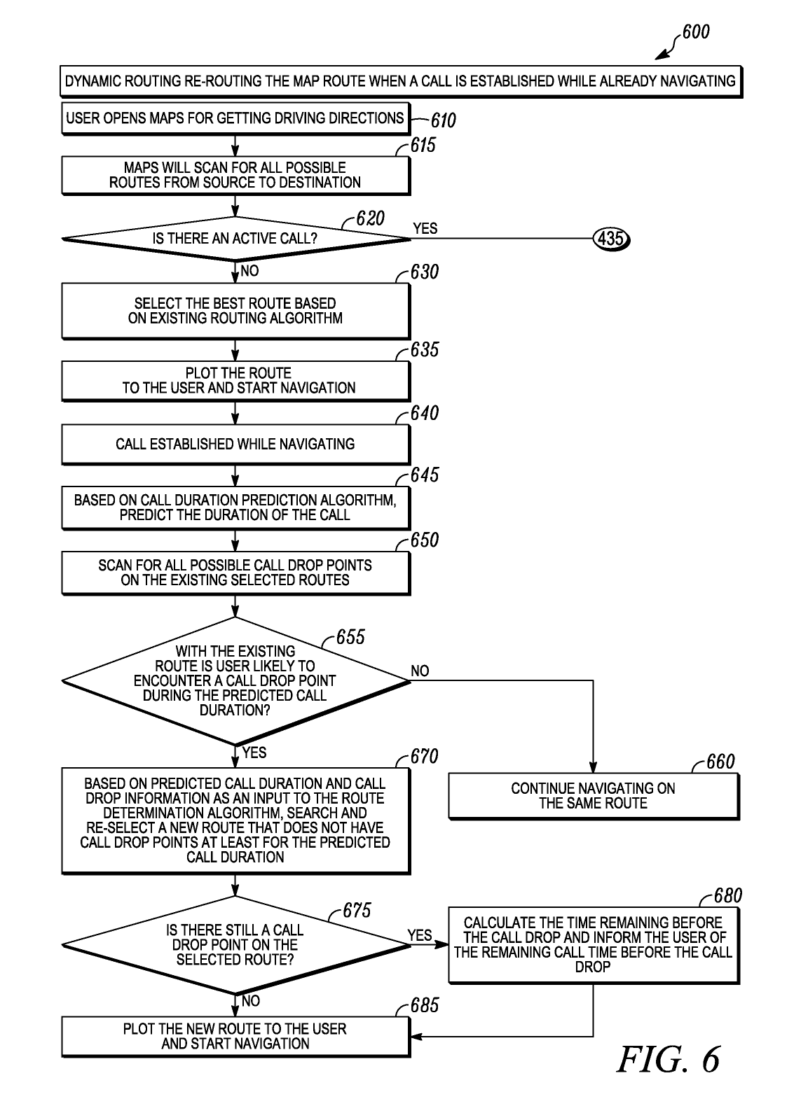

The map information shown on interface 320 can include information in addition to routes. For instance, text directions associated with a suggested route can be provided to the user. Locations on the map can be provided with hyper-linked icons whose selection will cause information to be broadcast to the user. Other information could include annotations associated with points of interest along the travel route. The annotations displayed to the user can be selected based on personal preferences optionally shared by the user with the route determination system. The route determination system may operate in accordance with the flowcharts depicted in FIGS. 4, 6 and/or 7.

Optionally, the interface 320 can display areas of low wireless coverage 390 on the mobile device. The areas of low wireless coverage 390 can be determined from information stored in memory 216 or may be provided by GPS components 222 in communication with or integral to mobile device 310. The areas of low wireless coverage 390 can be rendered as a highlighted portion along travel routes in the map displayed on interface 320. In some embodiments, the methods for determining a travel route discussed herein avoid areas of low wireless coverage 390 (i.e., data stalls or out of service), providing a travel route that increases wireless access for the traveler.

FIG. 4 is a flowchart for a method 400 for determining a travel route when a user is already on an active call when he starts traveling and would like to continue on the call while he is traveling. In some embodiments, when a user launches a navigation application, the navigation application infers the user to be on a call and predicts the remaining call duration. Using this predicted call duration and call drop points, an optimal travel route may be provided to the user.

Method 400 starts at block 410. In accordance with method 400, the user is already engaged in an active phone call. As used herein, an active call is a call that the user is currently or already engaged on. At block 415, the user opens a map service or navigation application for obtaining driving directions from the user's current location or origin to the user's desired destination. For example, FIG. 3 depicts origin 330 and destination 340. Such map service or navigation application may be a software application that a user interfaces and interacts with. For example, the navigation application can collect requested or required data and determine various travel routes, such as routes A (350), B (360) and C (370). Phone users will interact with the navigation application to obtain navigation details/travel options. In some embodiments, the navigation application is provided by navigation application module 224 and executed in memory 216. As provided above, in some embodiments, the navigation application module 224 is configured to interact with components such as GPS, cloud server, internal memory to obtain and provide additional navigation details to the navigation module.

At block 420, the navigation application scans for all possible routes from the user's origin to destination. In some embodiments, the navigation application scans for a subset of all possible routes, such as using a favorites setting, avoiding highways, maximizing highways, etc.

At decision block 425, the navigation application checks to see if the user is engaged on an active call (e.g. the call from block 410 or a new call). If the user is no longer engaged on an active call, at block 430 the navigation application selects the best route based on a routing algorithm. In some embodiments, when the user is not on a call, the routing algorithm does not necessarily need to factor in call drop points along the selected route.

If the user is engaged on an call, at block 435, the navigation application predicts the duration of the on-going call. In some embodiments, the navigation application uses a call duration prediction algorithm to predict the duration of the on-going call. Such call duration prediction algorithms may be known to one of skill in the art. An example call duration prediction algorithm is provided in International Publication No. WO 2013003035 A1, incorporated herein by reference in its entirety. In some embodiments, the call duration prediction algorithm uses various context information to predict the call duration. Such context information may include various factors relating to the user or user's mobile device such as time, location, calendar entries, behavior or historical log. For example, the time parameter of the context information may include an indication of weekday, weekend, or a holiday, time of the day, whether the user is on vacation, etc. The location parameter of the context information may include whether the user takes longer calls with a particular person. Call behavior may include call statistics of the user based on the previous call history, e.g. how the user uses the phone for making calls. For example, after leaving from office to home, the user typically makes a call to home to inform that he left the office. Additional context information may include default parameters such as live feeds on traffic status, best route, shortest path, data stall points, low data rate, out of service area, etc. Additional information such as travel parameters may also be used, where travel parameters may include estimated travel time, distance, average speed, weather, preferred routing information, shortest path, and traffic information.

At block 440, the navigation application scans for possible call drop points on all possible routes. Call drop points may be determined/collected using various methodologies commonly known in the art such as described in European patent application EP1284579 A1 or U.S. Patent application US20120220290 A1.

At block 445, the navigation application uses the predicted call duration and call drop information obtained at block 440, as inputs to a route determination algorithm. In some embodiments, such inputs provide the best route that minimizes or eliminates call drop points for the predicted call duration. For example, referring back to FIG. 3, let's assume that route A 350 is the best route between origin 330 and destination 340. If the predicted call duration suggests that the call will end before the user reaches point 330 along route A 350, the navigation application may plot route A for the user. However, if the time remaining before the call drop suggests that the call will be on-going when the user reaches point 330, the navigation application may select a route that includes route A 350 until point 1 shown in FIG. 3 and then route B 360.

If at decision block 450, the navigation application determines that there is not a call drop point on the selected route, the navigation application plots the route to the user and begins navigation (block 460).

If at decision block 450, the navigation application determines that there is a call drop point on the selected route, such as call drop point 395 shown in FIG. 3, the navigation application calculates the time remaining before the call drop and informs the user of the remaining call time before the call drop (block 455). The navigation application then plots the route to the user and starts navigation (block 460). In some embodiments, the navigation application selects the route having the call drop point the farthest away (such as call drop point 395), allowing the user to continue on with his call for the longest time period. This methodology allows the user to decide if he wishes to continue his call or end it before reaching the call drop point.

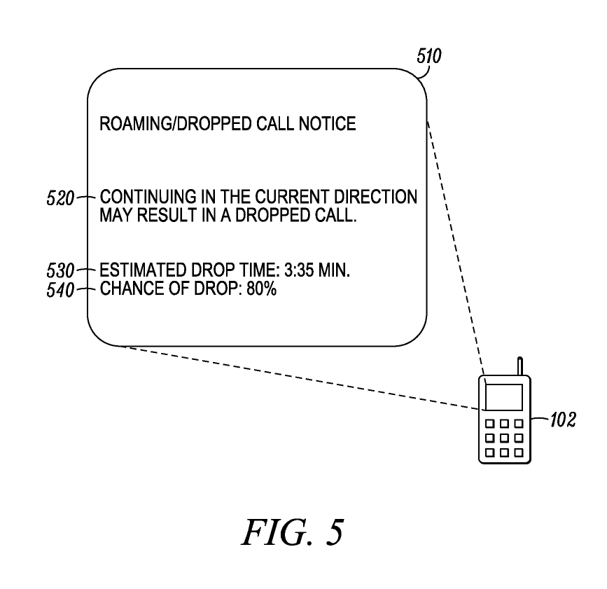

FIG. 5 illustrates a generalized schematic of an example notification 510 provided to a user of an impending call drop, such as determined at decision block 450. Notification 510 may be any of the known types of notifications currently in use with mobile devices, or any type of notification that alerts the user that the communication is soon to be dropped. In some embodiments, a text message 520 may be sent to mobile device 102, which may be accompanied by an audible notification so that user can detect the notification while participating in a voice call. Message 520 may be displayed on mobile device display 208. Message 520 may notify user that the call may be dropped or one or more services may be lost if user continues on the current route.

As provided above, the notification 510 may also provide an estimate to user of approximately how long the user can maintain the current wireless connection or service before it is dropped, as indicated by numeral 530. Such an estimate may be generated in any way known to those skilled in the art, and may take into account the direction and speed of user, as obtained, for example, from current and historical GPS coordinates or other GPS information gathered from mobile device 102. The notification 510 may also include the likelihood or probability, for example in the form of a percentage, that the call will be dropped or that the service will be lost, as indicated by numeral 540. This probability of a call drop or loss of one or more services 540 may be derived, directly or indirectly, from the gathered network statistics.

In some embodiments, notification 5101 repeatedly sent to mobile device 102 as long as mobile device 102 continues to be actively participating in a communication. This will serve as a reminder to the user that steps should be taken to gracefully terminate the call or communication soon, or to take other steps to ensure that mobile device 102 stays within the coverage area of the wireless provider network (e.g., served by base station 108). In another embodiment, the probability of the call dropping or service loss 540 and the estimated time of drop or loss 530 is continuously updated, for example in real-time or near real-time at predetermined time increments, so that the user can be made aware of the current status of a potential call drop or loss of service.

FIG. 6 is a flowchart for a method 600 for determining a travel route according to dynamic routing. Dynamic routing is applicable to scenarios when a user is already traveling/navigating using a navigation application and a call is placed that may necessitate re-routing the map route to minimize/eliminate dropped calls. In some embodiments, the navigation application predicts the call duration and uses this call duration prediction and call drop points to determine an optimal travel route for the user.

Method 600 starts at block 610. In accordance with some embodiments, a user opens a navigation application for obtaining directions from an origin to a destination. At block 615, the navigation application scans for all possible routes from the origin to destination. In some embodiments, the navigation application scans for a subset of all possible routes, such as using a favorites setting, avoiding highways, maximizing highways, etc.

At decision block 620, the navigation application determines whether the user is engaged on an active call. If the user is on an active call, the method proceeds according to the flowchart of FIG. 4 starting with block 435.

If the user is not on an active call, at block 630 the navigation application selects the best route, such as route A 350 shown in FIG. 3, based on a known routing algorithm. At block 635, the navigation application plots the route to the user and starts navigation.

At block 640, a phone call is established and/or detected while en route or navigating. At 645, the navigation application predicts the duration of the call, such as by using a call duration prediction algorithm, described above with reference to FIG. 4.

At block 650, the navigation algorithm scans for all possible call drop points on the existing route, selected at block 630. At decision block 655, the navigation algorithm determines whether the user is likely to encounter a call drop point during the predicted call duration on the existing route. If there is not a call drop point, at block 660, the navigation application continues navigating along the same route.

If there is a call drop point along the selected route, at block 670, the navigation application utilizes the call duration prediction and call drop information as an input to a route determination algorithm to determine whether to re-route the user. Referring back to FIG. 3, when the call duration prediction and call drop information suggest that the call will end before the user reaches call drop point 330 along route A 350, the navigation application would determine not to re-route the user. However, when the call duration prediction and call drop information suggest that the call will be on-going when the user reaches call drop point 330, the navigation application may decide to select a new route that minimizes/eliminates call drop points for the predicted call duration. For example, the navigation application may select route B 360 when the user reaches point 1 shown in FIG. 3.

At decision block 675, the navigation application determines if there is still a call drop point on the selected route. If there is not a call drop point, at block 685, the navigation application plots the new route to the user and starts navigating.

If there is a call drop point on the selected route, at block 680, the navigation application calculates the time remaining before the call drop and informs the user of the remaining call time before the call drop, such as described in FIG. 5. In the current embodiment described, the navigation application selects the route having the call drop point (point 395) the farthest away, allowing the user to continue on with his call for the longest time period.

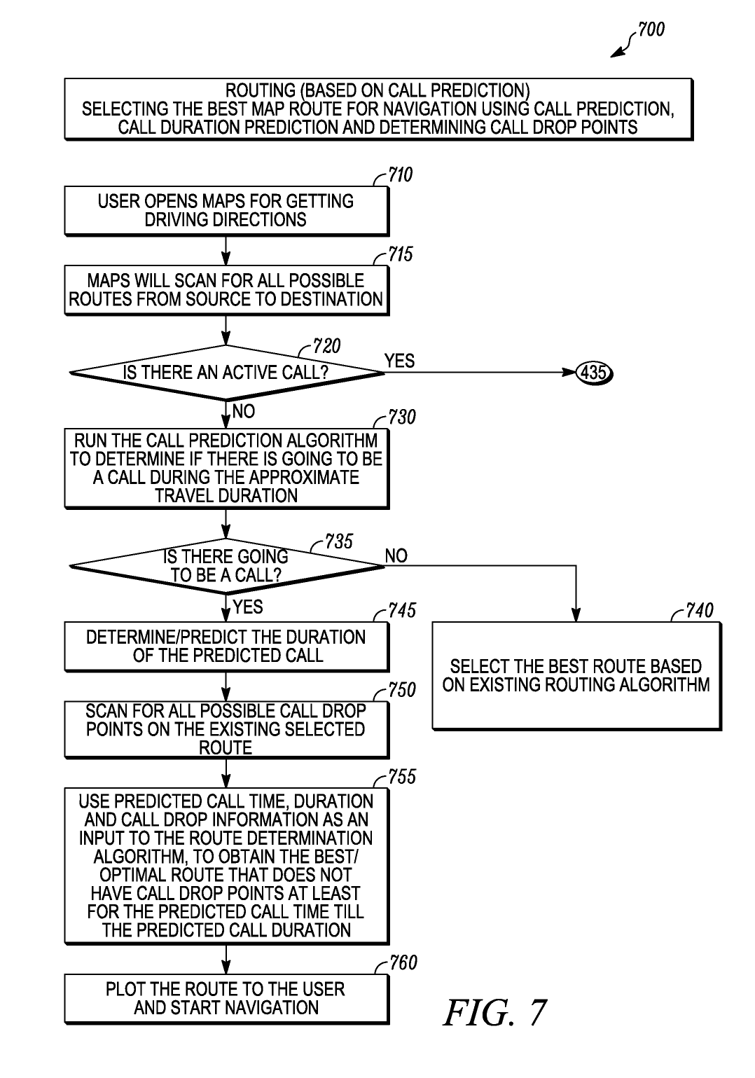

FIG. 7 is a flowchart for a method 700 for determining a travel route when a user is predicted to start an active call during traveling. The call prediction may be made using context information, such as an upcoming calendar meeting for a conference call. In some embodiments, the call prediction, in addition to call duration prediction (such as knowing the duration of the calendar meeting for the conference call) and call drop points may be used to select an optimal travel route for the user.

Method 700 starts at block 710. In accordance with method 700, the user is predicted to start a phone call during traveling. At block 710, the user opens the map service/navigation application to obtain driving directions from an origin to destination. At block 715, the navigation application scans for all possible routes from the user's origin to destination. In some embodiments, the navigation application scans for a subset of all possible routes, such as using a favorites setting, avoiding highways, maximizing highways, etc.

At decision block 720, the navigation application determines whether the user is engaged on an active call. If the user is on an active call, the navigation application routes the user according to method 400, beginning at block 435.

If the user is not on an active call, at block 730, the navigation application runs a call prediction algorithm to determine whether the user will likely be engaged in a call during the approximate travel duration. Such call prediction algorithms are known to one of ordinary skill in the art. An example call prediction algorithm is provided in Phithakkitnukoon, Santi, and Ram Dantu. “Towards ubiquitous computing with call prediction.” ACM SIGMOBILE Mobile Computing and Communications Review 15.1 (2011): 52-64. At decision block 735, the navigation application determines whether the user will likely be engaged in a call. If not, at block 740, the navigation application selects the best route using an existing routing algorithm.

If the navigation application determines that the user is likely to be engaged in a call, at block 745, the navigation application determines/predicts the duration of the predicted call. At block 750, the navigation application scans for possible call drop points on the existing selected route. At block 755, the navigation application uses the predicted call time, call duration and call drop information as an input to a route determination algorithm route the user. For example, in some embodiments, the route determination algorithm searches and selects a route that minimizes/eliminates call drop points for the predicted call time and call duration as described previously with respect to FIGS. 4 and 6 in combination with FIG. 3. It should be appreciated that the route determination algorithm may be known to one of skill in the art. At block 770, the navigation application plots the route to the user and starts navigation.

In accordance with the present disclosure, benefits provided include: (1) making navigation applications intelligent enough to predict call duration along with call drop information to determine whether to re-route or remain on the existing route; and (2) making navigation applications intelligent enough to predict the likelihood or occurrence of a call along with call drop information to determine whether to re-route or remain on the existing route.

In addition, in some embodiments, the navigation application will neither re-route nor provide any indication to the user about a possible call drop point while on a call. Rather, it will just keep navigating on the existing route. For example, while navigating, the mobile device becomes engaged on a phone call and a call duration prediction algorithm predicts the call duration to be 9 minutes. The navigation application also locates a call drop point on the existing route and calculates the approximate time to reach the call drop point using a plurality of factors or context information (such as speed, distance, traffic, climate, etc.). If in this example, it is estimated to take 27 minutes to reach the call drop point, the navigation application will not change its course or provide any such indication of the call drop point to the user because it is not likely to affect the user. In such a scenario, the user will remain completely unaware of the possible call drop point.

In some embodiments, the navigation application will re-route without user notification if it determines that the call duration coincides with a call drop point. For example, while navigating, the mobile device becomes engaged on a call and a call duration prediction algorithm predicts the call duration to be 30 minutes. The navigation application also locates a call drop point on the existing route and calculates the approximate time to reach the call drop point to be 15 minutes. In one embodiment, the navigation application may: (1) check for all possible alternative routes and calculate the existence of call drop points on all of these routes; (2) select the best route that either has a call drop point that does not coincide with the call duration or does not have a call drop point; and (3) provide an indication to the user only if there are no alternative routes.

In some embodiments, when the navigation application is launched, it will generate a route based on a call prediction algorithm. For example, while the navigation application is launched to travel from an origin to a destination, the navigation application will check for the possibility of a call via a call prediction algorithm. In one example, a conference call predicted to last 30 minutes (call prediction) that, based on a calendar notice, is scheduled to start at 2:00 pm (call start time) is determined. The navigation application may: (1) check for all possible routes and calculate the existence of call drop points on all these routes starting at 2:00 pm and onward; (2) select the best route that does not have a call drop point between 2:00 pm and 2:30 pm (call start time+30 minute duration); (3) provide an indication to the user of the possibility of the call and a call drop point coinciding in the route if there are no available alternate routes; and (4) not provide any indication to the user about call drop points existing before and after the call time and call duration if the call drop points do not coincide with the call.

In some embodiments, the call statistics/map information required for routing and determining the travel route is cached and/or updated periodically. This information may be used to provide a similar experience if offline maps are used for navigation.

Additionally, in some embodiments, the travel routes provided are not limited to using call drop points and may be extended to provide better coverage to other wireless services such as data stall, out of service etc.

In a first aspect, a method for determining an optimal travel route from an origin to a destination for a first device is disclosed including: determining an origin and destination for a travel objective; determining whether a user is one of on a phone call and predicted to be on a phone call during the travel objective using context information associated with the first device; and when the user is on a phone call, determining a phone call duration using the context information associated with the first device; and determining an optimal travel route of a plurality of travel routes based on the phone call duration and call drop information; or when the user is predicted to be on a phone call, determining whether the phone call is predicted to be on-going when a call drop point is encountered, when the phone call is predicted to be on-going when the call drop point is encountered, determining a phone call duration using the context information associated with the first device; and determining an optimal travel route of a plurality of travel routes based on the phone call duration and call drop information. In an embodiment of the first aspect, the context information includes at least one of a time, location, behavior, calendar event and historical log associated with the first device. In an embodiment of the first aspect, the determining a travel route is also based on a travel parameter that includes at least one of an estimated travel time, distance, average speed, weather, preferred routing information, shortest path, and traffic information. In an embodiment of the first aspect, the call drop information includes call drop points along a path from the origin to the destination. In an embodiment of the first aspect, determining a travel route includes selecting a travel route that prevents call drops. In an embodiment of the first aspect, determining a travel route includes selecting a travel route that prevents data stalls or out of service. In an embodiment of the first aspect, determining a travel route includes informing the user of a possible call drop if the determined travel route has an unavoidable call drop point. In an embodiment of the first aspect, informing the user of a possible call drop includes providing the user with a remaining call time before the call drop will be encountered. In an embodiment of the first aspect, when all travel routes of the plurality of travel routes have call drop points, determining the optimal travel route further includes selecting a route which has the farthest call drop point and informing the user of the call drop point.

In a second aspect, a method for determining an optimal travel route from an origin to a destination for a first device is disclosed including: determining an origin and destination for a travel objective; determining a first optimal travel route of a plurality of travel routes; determining that a user is on a phone call; and when the phone call is predicted to be on-going when a call drop point is encountered, determining a phone call duration using context information associated with the first device; and determining a second optimal travel route of a plurality of travel routes based on the phone call duration and call drop information; or when the phone call is predicted not to be on-going when a call drop point is encountered; remaining on the first optimal travel route of a plurality of travel routes. In an embodiment of the second aspect, determining the second optimal travel route includes: re-routing the user to an alternate route that has no call drop points within the predicted duration of the phone call. In an embodiment of the second aspect, if all alternate travel routes have call drop points, re-routing the user to an alternate route which has the farthest call drop point and informing the user of the call drop point. In an embodiment of the second aspect, the method further includes: caching the phone call duration and at least one of a travel parameter and call drop information used in determining the optimal travel route.

In a third aspect, a communication device for determining a travel route is disclosed including: an antenna; a transceiver coupled to said antenna for transmitting to, and receiving communications from, a wireless network; a processor configured to: determine an origin and destination for a travel objective; determine whether a user is one of on a phone call and predicted to be on a phone call during the travel objective using context information associated with the first device; and when the user is on a phone call, determine a phone call duration using the context information associated with the first device; and determine an optimal travel route of a plurality of travel routes based on the phone call duration and call drop information; or when the user is predicted to be on a phone call, determine whether the phone call is predicted to be on-going when a call drop point is encountered, when the phone call is predicted to be on-going when the call drop point is encountered, determine a phone call duration using the context information associated with the first device; and determine an optimal travel route of a plurality of travel routes based on the phone call duration and call drop information. In an embodiment of the third aspect, the context information includes at least one of a time, location, behavior, calendar event and historical log associated with the first device. In an embodiment of the third aspect, determine an optimal travel route is also based on a travel parameter that includes at least one of an estimated travel time, distance, average speed, weather, preferred routing information, shortest path, and traffic information. In an embodiment of the third aspect, the call drop information includes call drop points along a path from the origin to the destination. In an embodiment of the third aspect, determine an optimal travel route includes selecting a travel route that prevents call drops. In an embodiment of the third aspect, determine an optimal travel route includes selecting a travel route that prevents data stalls or out of service. In an embodiment of the third aspect, determine an optimal travel route includes informing the user of a possible call drop if the determined travel route has an unavoidable call drop point. In an embodiment of the third aspect, informing the user of a possible call drop includes providing the user with a remaining call time before the call drop will be encountered. In an embodiment of the third aspect, when all travel routes of the plurality of travel routes have call drop points, determining the optimal travel route further includes selecting a route which has the farthest call drop point and informing the user of the call drop point.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method for determining an optimal travel route from an origin to a destination for a first device, the method comprising:
determining an origin and destination for a travel objective;
determining whether a user is one of on a phone call and predicted to be on a phone call during the travel objective using context information associated with the first device; and
when the user is on a phone call,
determining a phone call duration using the context information associated with the first device; and
determining an optimal travel route of a plurality of travel routes based on the phone call duration and call drop information; or
when the user is predicted to be on a phone call,
determining whether the phone call is predicted to be on-going when a call drop point is encountered,
when the phone call is predicted to be on-going when the call drop point is encountered,
determining a phone call duration using the context information associated with the first device; and
determining an optimal travel route of a plurality of travel routes based on the phone call duration and call drop information.

2. The method of claim 1, wherein the context information comprises at least one of a time, location, behavior, calendar event and historical log associated with the first device.

3. The method of claim 1, wherein the determining a travel route is also based on a travel parameter that comprises at least one of an estimated travel time, distance, average speed, weather, preferred routing information, shortest path, and traffic information.

4. The method of claim 1, wherein the call drop information comprises call drop points along a path from the origin to the destination.

5. The method of claim 1, wherein the determining a travel route comprises selecting a travel route that prevents call drops.

6. The method of claim 1, wherein the determining a travel route includes selecting a travel route that prevents data stalls or out of service.

7. The method of claim 1, wherein the determining a travel route comprises informing the user of a possible call drop if the determined travel route has an unavoidable call drop point.

8. The method of claim 7, wherein informing the user of a possible call drop comprises providing the user with a remaining call time before the call drop will be encountered.

9. The method of claim 1, wherein when all travel routes of the plurality of travel routes have call drop points, determining the optimal travel route further comprises selecting a route which has the farthest call drop point and informing the user of the call drop point.

10. A method for determining an optimal travel route from an origin to a destination for a first device, the method comprising:
determining an origin and destination for a travel objective;
determining a first optimal travel route of a plurality of travel routes;
determining that a user is on a phone call; and
when
the phone call is predicted to be on-going when a call drop point is encountered, determining a phone call duration using context information associated with the first device; and
determining a second optimal travel route of a plurality of travel routes based on the phone call duration and call drop information; or
when
the phone call is predicted not to be on-going when a call drop point is encountered;
remaining on the first optimal travel route of a plurality of travel routes.

11. The method of claim 10, wherein determining the second optimal travel route comprises:
re-routing the user to an alternate route that has no call drop points within the predicted duration of the phone call.

12. The method of claim 11, wherein if all alternate travel routes have call drop points, re-routing the user to an alternate route which has the farthest call drop point and informing the user of the call drop point.

13. The method of claim 1, further comprising:
caching the phone call duration and at least one of a travel parameter and call drop information used in determining the optimal travel route.

14. A communication device for determining a travel route, the device comprising:
an antenna;
a transceiver coupled to said antenna for transmitting to, and receiving communications from, a wireless network;
a processor configured to:
determine an origin and destination for a travel objective;
determine whether a user is one of on a phone call and predicted to be on a phone call during the travel objective using context information associated with the first device; and
when the user is on a phone call,
determine a phone call duration using the context information associated with the first device; and
determine an optimal travel route of a plurality of travel routes based on the phone call duration and call drop information; or
when the user is predicted to be on a phone call,
determine whether the phone call is predicted to be on-going when a call drop point is encountered,
when the phone call is predicted to be on-going when the call drop point is encountered,
determine a phone call duration using the context information associated with the first device; and
determine an optimal travel route of a plurality of travel routes based on the phone call duration and call drop information.

15. The device of claim 14, wherein the context information comprises at least one of a time, location, behavior, calendar event and historical log associated with the first device.

16. The device of claim 14, wherein the determine an optimal travel route is also based on a travel parameter that comprises at least one of an estimated travel time, distance, average speed, weather, preferred routing information, shortest path, and traffic information.

17. The device of claim 14, wherein the call drop information comprises call drop points along a path from the origin to the destination.

18. The device of claim 14, wherein the determine an optimal travel route comprises selecting a travel route that prevents call drops.

19. The device of claim 14, wherein the determine an optimal travel route includes selecting a travel route that prevents data stalls or out of service.

20. The device of claim 14, wherein the determine an optimal travel route comprises informing the user of a possible call drop if the determined travel route has an unavoidable call drop point.

21. The device of claim 20, wherein informing the user of a possible call drop comprises providing the user with a remaining call time before the call drop will be encountered.

22. The device of claim 14, wherein when all travel routes of the plurality of travel routes have call drop points, determining the optimal travel route further comprises selecting a route which has the farthest call drop point and informing the user of the call drop point.
